(19) United States
(12) Patent Application Publication
(10) Pub. No.: US 2004/0131366 A1
(43) Pub. Date: Jul. 8, 2004

(54) Wavelength tunable optical transmitter, optical transponder and optical transmission system

(76) Inventors: Hideaki Tsushima, Komae (JP); Yukio Hayashi, Fujisawa (JP); Sunao Kakizaki, Kawasaki (JP)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 10/737,659

(22) Filed: Dec. 16, 2003

Related U.S. Application Data
(63) Continuation of application No. 09/638,554, filed on Aug. 14, 2000.

(30) Foreign Application Priority Data
Mar. 16, 2000 (JP) 2000-079295

(51) Int. Cl. H04B 10/02

(52) U.S. Cl. 398/197

(57) ABSTRACT

A wavelength tunable optical transmitter is used in a protection system of a WDM network, and its conventional wavelength tuning process has to perform steps of tuning intermediate wavelengths which are used by other optical transmission equipment in the network. Thus the conventional system interferes with normal communications in the other optical transmission equipment. To prevent the interference, wavelength tunable optical transmission equipment is provided with an optical gate for selectively on and off an optical signal output. A controller closes the optical gate while wavelength tunable optical transmission equipment and opens the optical gage to pass the signal through the optical gate once the target wavelength is attained and virtually stabilized.

### BACKGROUND OF THE INVENTION

This invention relates to optical fiber transmission system technologies based on wavelength division multiplexing (hereinafter called WDM) to send optical signals at different wavelengths on an optical fiber and particularly to wavelength tunable optical transmission equipment and an optical network using this type of transmission equipment.

An optical source with tunable wavelengths has been described, for example, in U.S. Pat. No. 5,173,909 (Japanese Patent Application Provisional Publication No. 72783/92). It is possible to realize wavelength tunable optical transmission equipment by the use of this type of optical source. This wavelength tunable optical transmission equipment has been attracting attention as auxiliary transmission equipment for WDM networks that have been recently gaining share. The reason is as follows. If conventional wavelength-fixed optical transmission equipment is used in WDM networks, a duplicate number of expensive optical transmitters is needed in order to provide a protection system. On the other hand, if wavelength tunable optical transmission equipment is adopted for the protection system, it is possible to reduce the required number of protection optical transmitters based upon a number of wavelengths available within the wavelength tunable range.

### SUMMARY OF THE INVENTION

A problem can arise if the above wavelength tunable optical transmission equipment is used in a WDM network. In a WDM network, when changing the wavelength (e.g. λ1) of certain optical transmission equipment to a different 5 wavelength (e.g. λ4), continuous transition from the current wavelength λ1 to the new wavelength λ4 via wavelengths λ2 and λ3 would occur in the wavelength tuning process and thus the transmission equipment would pass through steps of intermediate wavelengths λ2 and λ3. However, wavelengths λ2 and λ3 are delivered by other optical transmission equipment and used for transmission of other optical data signals. Within the network, there are also pieces of optical receiving equipment that receive optical signals at the wavelengths λ2, λ3.

Consequently, these pieces of optical receiving equipment are compelled to receive the optical signals at λ2 and λ3 that were generated in the wavelength tuning process by the above wavelength tunable optical transmission equipment. In addition, other optical transmission equipment may simultaneously delivers optical signals at λ2 and λ3 wavelengths to the same optical receiving equipment. This prevents the optical receiving equipment from receiving signals properly.

The object of this invention is to provide optical transmission equipment that solves the above problem as well as an optical network which uses such optical transmission equipment. The object is achieved by wavelength tunable optical transmission equipment with an optical gate which selectively allows an output optical signal to pass. A controller closes the optical gate to block signal output while wavelength tuning is under way in the transmission equipment, and opens it to allow output signals to pass through it once the target wavelength is attained and virtually stabilized.

### BRIEF DESCRIPTION OF THE DRAWINGS

Preferred embodiments of the present invention will now be described in conjunction with the accompanying drawings, in which:

FIG. 1 is a block diagram illustrating a first embodiment of the wavelength tunable optical transmission equipment according to the invention,

FIGS. 2A to 2D are diagrams illustrating the wavelength tuning process in the embodiment of the wavelength tunable optical transmission equipment according to the invention,

FIG. 3 is a block diagram illustrating a second embodiment of the wavelength tunable optical transmission equipment according to the invention,

FIG. 4 is a block diagram illustrating a third embodiment of the wavelength tunable optical transmission equipment according to the invention,

FIG. 5 is a block diagram illustrating a fourth embodiment of the wavelength tunable optical transmission equipment according to the invention,

FIG. 6 is a block diagram illustrating a fifth embodiment of the wavelength tunable optical transmission equipment according to the invention,

FIG. 7 is a block diagram illustrating a sixth embodiment of the wavelength tunable optical transmission equipment according to the invention,

FIG. 8 is a block diagram illustrating a seventh embodiment of the wavelength tunable optical transmission equipment according to the invention,

FIG. 9 is a block diagram illustrating embodiment of the WDM network according to the invention, and

FIG. 10 is a block diagram illustrating another embodiment of a WDM network according to the invention.

### DESCRIPTION OF THE PREFERRED EMBODIMENTS

The preferred embodiments of the present invention are explained below referring to the drawings attached.

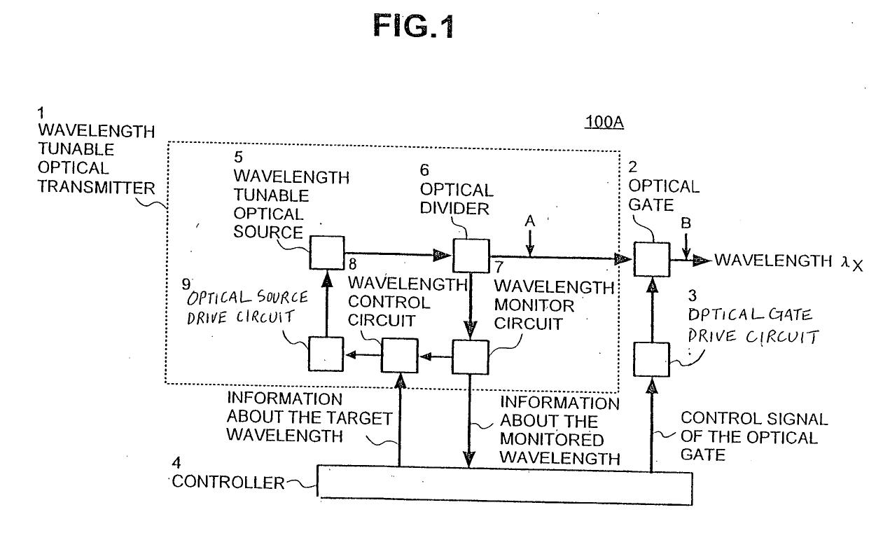

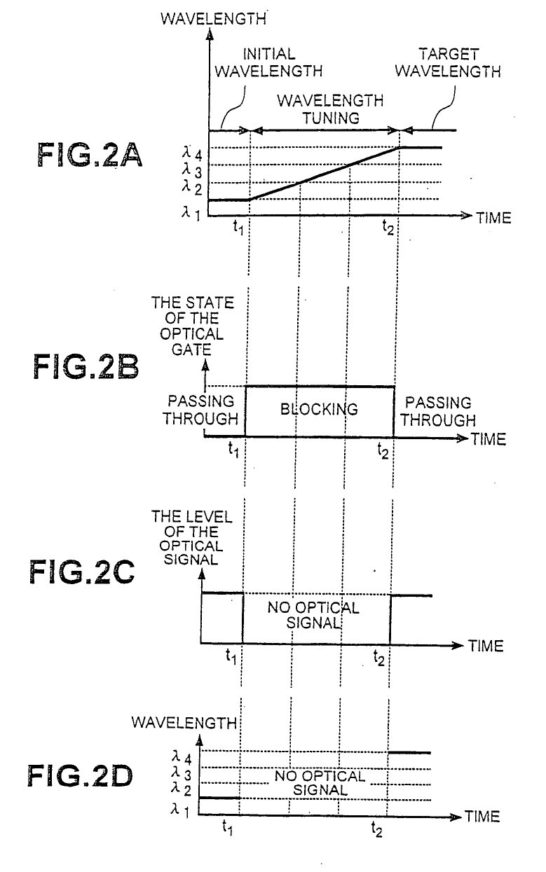

As a preferred embodiment of the optical transmission equipment according to the invention is described next with reference to FIGS. 1 and 2. FIG. 1 is a block diagram for the optical transmission equipment, and FIGS. 2A to 2D illustrate its wavelength tuning process.

Optical transmission equipment 100A as shown in FIG. 1 includes a wavelength tunable optical transmitter 1, an optical gate 2, an optical gate drive circuit 3 and a controller 4. The wavelength tunable optical transmitter 1 can tune wavelength λX of output optical signal. The optical gate 2 receives an optical input signal from the wavelength tunable optical transmitter 1 and blocks or pass the input signal. The optical gate drive circuit 3 drives the optical gate 2. The controller 4 outputs information about the target wavelength to a wavelength control circuit 8 of the wavelength tunable optical transmitter 1. The controller 4 receives information about the monitored wavelength from the wavelength monitor circuit 7 in the wavelength tunable optical transmitter 1. The controller 4 generates a control signal and outputs to the optical gate drive circuit 3, and based upon the control signal, the optical gate drive circuit 3 selectively makes the above optical gate 2 impassable while wavelength tuning is under way. The optical gate drive circuit 3 also makes the optical gate 2 passable once the target level of wavelength is attained and virtually stabilized.

The wavelength tunable optical transmitter 1 includes a wavelength tunable optical source 5, an optical divider 6, a wavelength monitor circuit 7, a wavelength control circuit 8 and an optical source drive circuit 9. The optical divider 6 divides the output from the wavelength tunable optical source 5 into two parts. One of the two parts is monitored as an input by the wavelength monitor circuit 7. The wavelength control circuit 8 generates a control signal so that the difference between the actual wavelength detected by the wavelength monitor circuit 7 and the target wavelength becomes close to zero. According to the signal from the wavelength control circuit 8, the optical source drive circuit 9 drives the wavelength tunable optical source 5. The wavelength monitor circuit 7 is implemented by a commercial spectrum analyzer or wavelength monitor and sends monitoring information to the controller 4. The wavelength control circuit 8 generates a control signal proportional to the difference between the target wavelength informed of by the controller 4 and the actually detected or monitored wavelength and is embodied by using such a circuit as typically used for negative feedback control. A device such as an optical switch or modulator is as the optical gate 2.

According to the above configuration, since the controller 4 not only controls the wavelength in the wavelength tunable optical transmitter 1 but also monitors the actual wavelength, it is possible to realize optical transmission equipment which makes the optical gate 2 selectively impassable during the wavelength tuning process and subsequently makes it passable once the wavelength is virtually stabilized at the target level.

FIGS. 2A to 2D illustrate the operations of the first embodiment. Shown here as an example is the wavelength transition in FIGS. 2A and FIG. 2D for the wavelength λX to be outputted from the wavelength tunable optical transmission equipment. As the wavelength is changed from the initial wavelength λ1 to the target wavelength λ4, the optical gate status transition as shown in FIG. 2B and the optical signal level transition as shown in FIG. 2C correspondingly change.

FIG. 2A shows the wavelengths of an optical signal to be sent to the optical gate in section A in FIG. 1. The wavelength is held at the initial level λ1 before time t1. The initial level λ1 gradually turns into wavelength λ2 and then to λ3, and finally reaches the target wavelength λ4 at time t2. Thereafter the wavelength remains stably at λ4. In parallel with this wavelength transition, the optical gate status as shown in FIG. 2B is controlled so that it is passable before time t1, and then it is impassable at time t1 and stays impassable until time t2. After time t2, it is passable again. In the above sequence, the optical signal level as shown in FIG. 2C in FIG. 1 during the period from t1 to t2 is null or substantially zero in an optical signal B. Therefore, the wavelength as shown FIG. 2D of the optical signal outputted from the optical gate is λ1 before t1 and λ4 after t2. In contrast, no optical signal is outputted from the optical gate during the period from t1 to t2. By controlling the optical gate in this way, communication between other optical transmission equipment and the receiving equipment using wavelengths λ2 or λ3 will not be disturbed. According to this embodiment, with the above arrangement, the wavelength tunable optical transmission equipment outputs no optical signal during the wavelength tuning process and outputs the tuned optical signal once the tuning is finished without affecting the characteristics of communications at other wavelengths during the tuning.

As the wavelength tunable optical source 5, a modulator-integrated optical source is one choice. If this type of optical source is used, an arrangement similar to the above described gate will be needed since there is no feedback to the wavelength control circuit. Alternatively, wavelength tuning is theoretically possible with the closed integrated modulator. The wavelength control circuit 8 is also incorporated in the controller 4 instead of in the wavelength tunable optical transmitter 1. This alternative arrangement applicable to the following other embodiments which will be described subsequently.

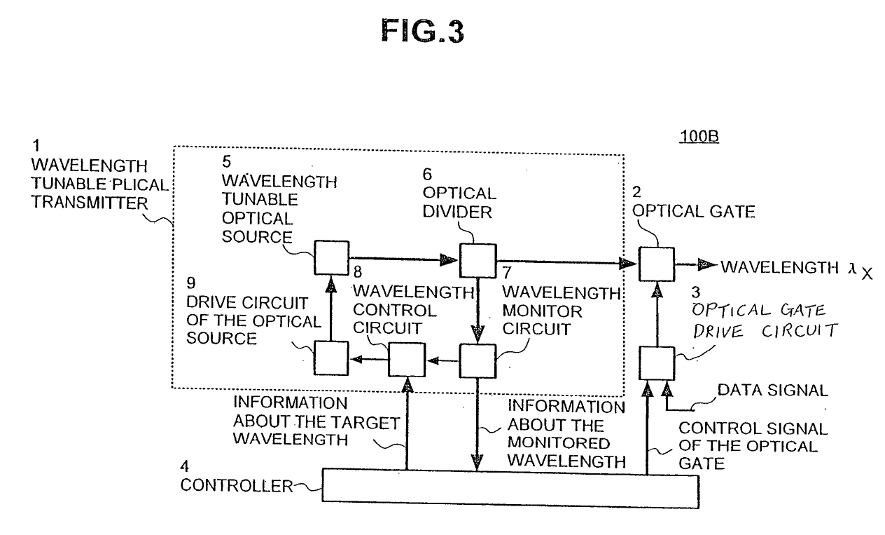

A second embodiment of the optical transmission equipment according to the present invention is explained below with reference to FIG. 3. The figure is a block diagram of the optical transmission equipment and the same reference numerals are used for the substantially identical components as in FIG. 1. These reference numerals will be also used for the same components in the subsequent embodiments discussed later.

The difference between the optical transmission equipment 100B in the second embodiment and the first embodiment 100A of FIG. 1 is that the optical gate 2 also serves as an optical modulator optical gate in the second embodiment 100B. Control signals from the controller 4 and data signal are inputted to the optical gate drive circuit 3 so that during normal data transmission, the optical gates selectively turns on or off the light from the wavelength tunable optical source 5 at a constant wavelength, according to a drive signal which depends on the data signal. Thereby the gate 2 permits the optical data signal to be output.

The optical gate 2 must operate at high velocity so it is preferably a Mach-Zehnder type external optical modulator which uses a semiconductor material or lithium niobate, or an electroabsorptive external optical modulator which uses a semiconductor material or a similar device.

In the second embodiment, the same wavelength tuning control as illustrated in FIGS. 1 and 2 is also implemented by replacing the control signal for optical gate drive circuit 3 from the data signal with the optical gate control signal from the controller 4. This also enables the wavelength tunable optical transmission equipment not to affect the characteristics of communications at other wavelengths during the wavelength tuning process.

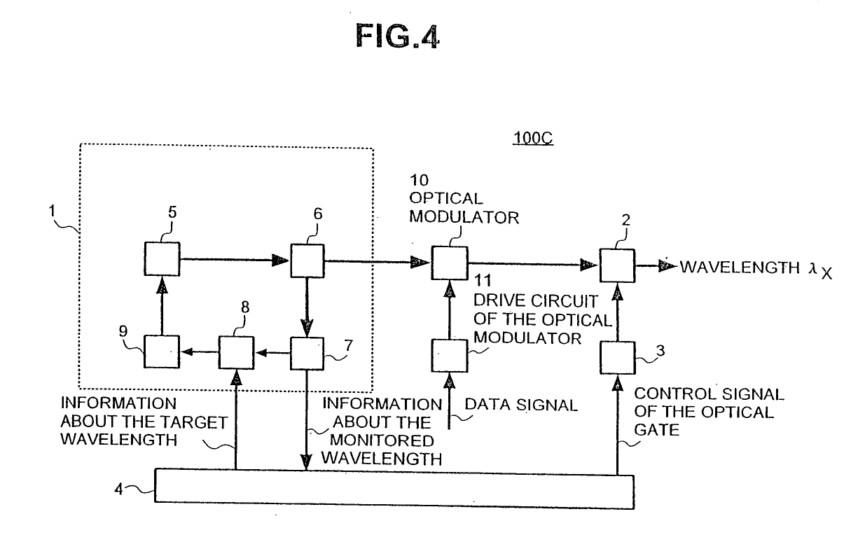

Referring to FIG. 4, a third embodiment of the optical transmission equipment according to the invention is next explained. FIG. 4 is a block diagram of the optical transmission equipment, and the optical transmission equipment 100C in this embodiment is different from the transmission equipment 100A in the first embodiment as shown in FIG. 1 in that it has an optical modulator 10 between the optical divider 6 and the optical gate 2. This optical modulator 10 is turned on or off by the optical modulator drive circuit 11 according to the drive signal which depends on the data signal so that optical data signal is selectively outputted.

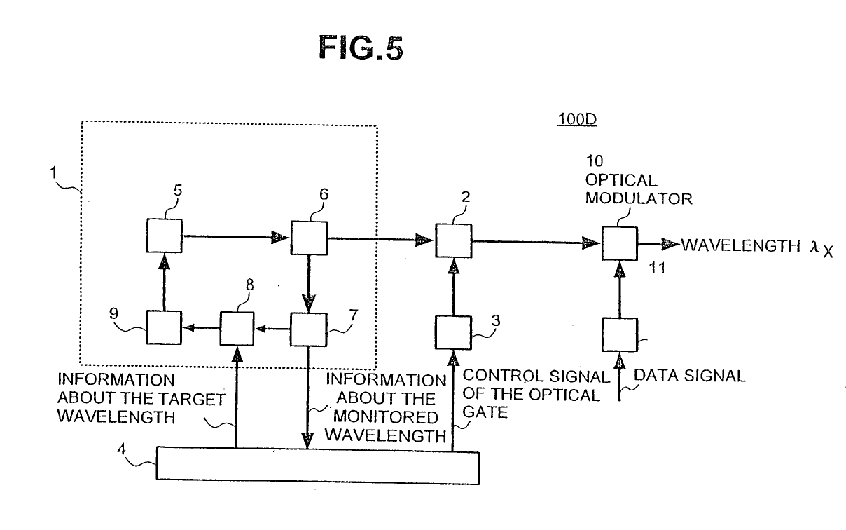

Referring to FIG. 5, a forth embodiment of the optical transmission equipment according to the invention will be next explained. FIG. 5 is a block diagram of the optical transmission equipment. The optical transmission equipment 100D in this embodiment is different from the transmission equipment 100A in the first embodiment as shown in FIG. 1 in that an optical modulator 10 is connected to the output of the optical gate 2. This optical modulator 10 is turned on or off by the optical modulator drive circuit 11 according to the drive signal which depends on the data signal so that optical data signal is selectively outputted.

In both the embodiments as shown in FIGS. 4 and 5, the optical modulator 10 is added to the embodiments as shown in FIG. 1. Thus, while wavelength tuning is under way as shown in FIG. 2, no optical signal can be outputted. After wavelength tuning is finished, an optical signal is outputted so that the wavelength tunable optical transmission equipment does not affect the characteristics of communications with other wavelengths during the wavelength tuning process.

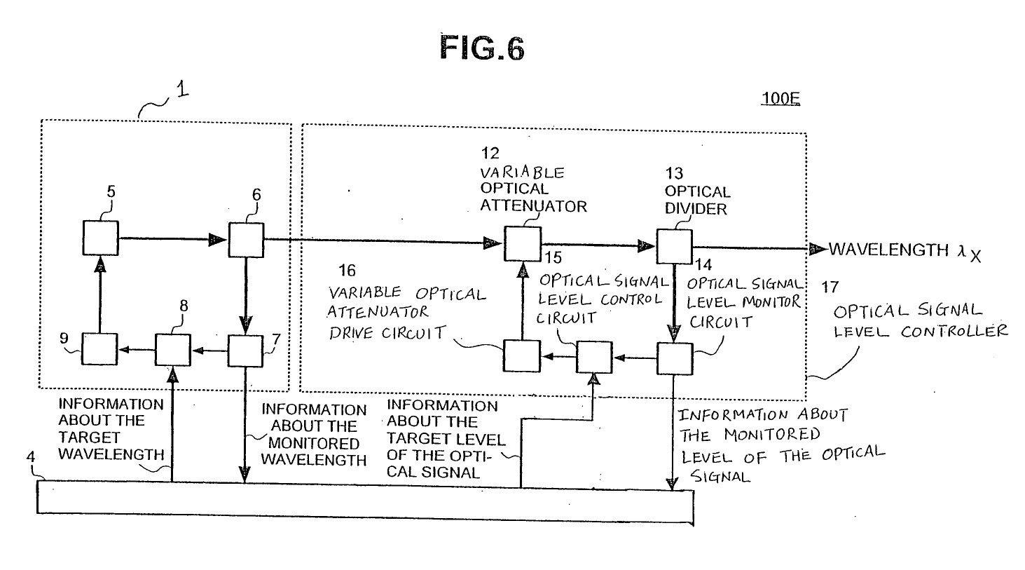

Referring to FIG. 6, a fifth embodiment of the optical transmission equipment according to the invention will be next explained. FIG. 6 is a block diagram of the optical transmission equipment. 100E that includes a wavelength tunable optical transmitter 1, an optical-signal level controller 17 and an optical controller 4. The wavelength tunable optical transmitter 1 modifies a wavelength λX of an output optical signal. An optical-signal level controller 17 receives the optical signal from the wavelength tunable optical transmitter 1 as an input and determines whether to permit it to pass through or block it. The controller 4 outputs information on the target wavelength to control the wavelengths of the wavelength tunable optical transmitter 1. The controller 4 also receives information on the monitored wavelength from the wavelength tunable optical transmitter 1. Based upon the received information, the controller 4 enables the optical-signal level controller 17 to block the optical signal while wavelength tuning is under way. The controller 4 also enables the optical-signal level controller 17 to permit the optical signal to pass through once the target level of wavelength is attained and virtually stabilized. The controller 4 receives information on the monitored optical signal level from the optical-signal level controller 17 and outputs a level control signal or information on the target optical signal level to control the output of the optical signal level controller 17.

The structure of the wavelength tunable optical transmitter 1 is the same as shown in FIG. 1. The optical-signal level controller 17 includes a variable optical attenuator 12, a second optical divider 13, a variable optical signal level monitor circuit 14, a variable optical signal level control circuit 15 and a variable optical attenuator drive circuit 16. The variable optical attenuator 12 attenuates the light from the wavelength tunable optical transmitter 1. The second optical divider 13 divides the light from the variable optical attenuator 12 into, for example, nine parts, or at a ratio of 9:1. The optical signal level monitor circuit 14 monitors the level of the optical signal from the second optical divider 13. The optical-signal level control circuit 15 compares the level of the electric signal as a result of conversion in the optical-signal level monitor circuit 14 with the target optical signal level informed of by the controller 4. Based upon the comparison, the optical signal level control circuit 15 generates a control signal indicative of the difference, and the control signal is used to make the difference zero. The variable optical attenuator drive circuit 16 drives the variable optical attenuator 12 according to the above control signal from the optical signal level control circuit 15. In one preferred embodiment, the variable optical attenuator 12 is implemented with a polymer-based variable optical attenuator or an erbium-doped fiber (EDF).

With the above described structures in the preferred embodiment, the controller 4 not only controls the wavelength of the wavelength tunable optical transmitter 1 but also monitors the actual wavelength so that the optical transmission equipment enables the variable optical attenuator 12 selectively to block optical signals during the wavelength tuning process. Upon returning to the state, where the target level of wavelength is attained and virtually stabilized, the optical transmission equipment allows the optical signal to pass through. According to the preferred embodiment, the wavelength tunable optical transmission equipment controls the variable optical attenuator 12 so as to bring the output optical signal to a prescribed level.

As in the first embodiment as shown in FIG. 1, a modulator-integrated optical source is used as the wavelength tunable optical source 5. In this case, however, an arrangement similar to the above described structure will be needed since there is no feedback to the wavelength control circuit. However, wavelength tuning is theoretically possible with the closed integrated modulator. Alternatively, the optical-signal level control circuit 15 is included in the controller 4 instead in the optical-signal level controller 17. This alternative approach is possible for the other embodiments discussed below.

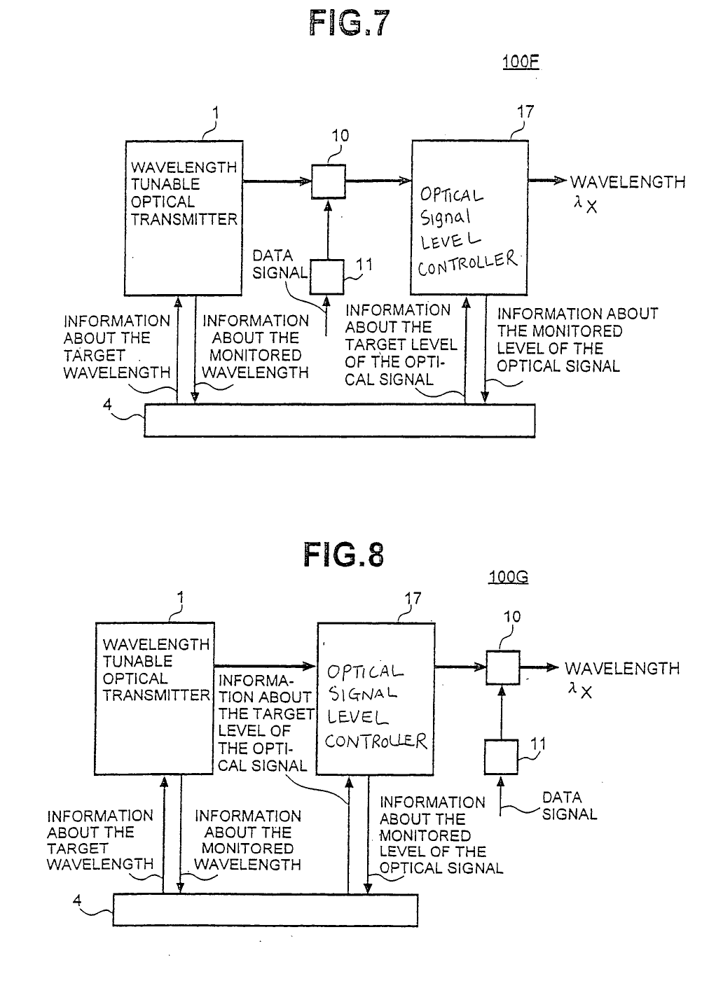

Referring to FIG. 7, a sixth embodiment of the optical transmission equipment according to the invention will be next explained. FIG. 7 is a block diagram of the optical transmission equipment. The optical transmission equipment 100F in this embodiment is different from the transmission equipment 100E as shown in FIG. 6 in that an optical modulator 10 is located between the wavelength tunable optical transmitter 1 and the optical-signal level controller 17. This optical modulator 10 is turned on or off by the optical modulator drive circuit 11 according to the drive signal which depends on the data signal so that optical data signal is outputted.

Referring to FIG. 8, a seventh embodiment of the optical transmission equipment according to the invention will be next explained. FIG. 8 is a block diagram of the optical transmission equipment. The optical transmission equipment 100G in this embodiment is different from the transmission equipment 100E as shown in FIG. 6 in that an optical modulator 10 is connected to the output of the optical-signal level controller 17. This optical modulator 10 is selectively turned on or off by the optical modulator drive circuit 11 according to the drive signal which depends on the data signal so that optical data signal is outputted.

In both the embodiments as shown in FIGS. 7 and 8, the optical modulator 10 is added to the configuration as shown in FIG. 6. In these embodiments, while wavelength tuning is under way as shown in FIG. 2, no optical signal can be outputted. After wavelength tuning is finished, an optical signal can be outputted so that both pieces of the wavelength tunable optical transmission equipment do not affect the characteristics of communications at other wavelengths even during the wavelength tuning process. The wavelength tunable optical transmission equipment also controls the variable optical attenuator 12 so as to bring the output optical signal to a prescribed level.

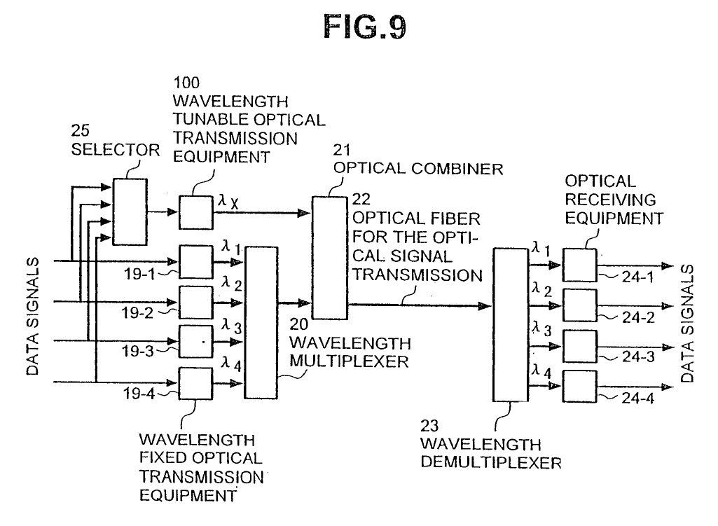

Referring to FIG. 9, a preferred embodiment of the WDM network according to this invention is explained. FIG. 9 is a block diagram of the WDM network. This embodiment assumes that four wavelength channels are provided for wavelength multiplexing. When the optical network is working normally, data signals are sent to the respective wavelength fixed optical transmission equipment 19-1 through 19-4 for the corresponding wavelengths λ1 through λ4. The output optical signal from each of the wavelength fixed optical transmission equipment 19-1 through 19-4 is wavelength-multiplexed by a wavelength multiplexer 20 and then transmitted through the optical fiber for the optical-signal transmission 22 to a wavelength demultiplexer 23 for wavelength demultiplexing. The demultiplexed separate optical signals at wavelengths are received by respective optical receiving equipment 24-1 through 24-4. During this process, outputs from the wavelength tunable optical transmission equipment 100 are blocked.

However, if a failure occurs in one of the above four pieces of wavelength fixed optical transmission equipment 19-1 through 19-4, the wavelength tunable optical transmission equipment 100 changes its status from an optical output blocking status to an optical output enabling status after the output wavelength is changed to λ4 and stabilized. At the same time, for example, if the transmission equipment 19-4 fails to output the λ4 signal, a selector 25 selects the data signal which was sent to 19-4 before the failure prior to outputting it.

As a result of the above operation, the wavelength tunable optical transmission equipment 100 outputs the same optical signal as the wavelength fixed optical transmission equipment 19-4. The output optical signal from the wavelength tunable optical transmission equipment 100 is combined or multiplexed with other wavelengths λ1 to λ3 by an optical combiner 21 before transmitted on the optical fiber 22. The optical combiner 21 is an optical component that connect optical signals regardless of wavelengths. For instance, an optical coupler is used as an optical combiner in the preferred embodiment.

A recovery sequence is achieved by the wavelength tunable optical transmission equipment 100 even if a failure occurs in either of the three other pieces of wavelength fixed optical transmission equipment 19-1 through 19-3 which respectively output wavelengths different from λ4. Any of the various types of the wavelength tunable transmission equipment, 100B, 100C, 100D and 100F with a modulator or either of the modulator-integrated optical sources 100A and 100E is used as wavelength tunable optical transmission equipment 100 in a preferred embodiment of the WDM network. The same is said of embodiments discussed below.

According to this embodiment, by providing one piece of wavelength tunable optical transmission equipment 100 mentioned above as an auxiliary unit in a WDM network using multiple pieces of wavelength fixed optical transmission equipment, the network recovers from the failure even if one of the above wavelength fixed optical transmission equipment fails. This recovery process also works even if two or more pieces of wavelength fixed optical transmission equipment fail at a time, the network resets to normal operation by using additionally available two or more pieces of wavelength tunable optical transmission equipment.

In this and subsequent embodiments, wavelength tunable optical transmission equipment is installed in place of wavelength fixed optical transmission equipment.

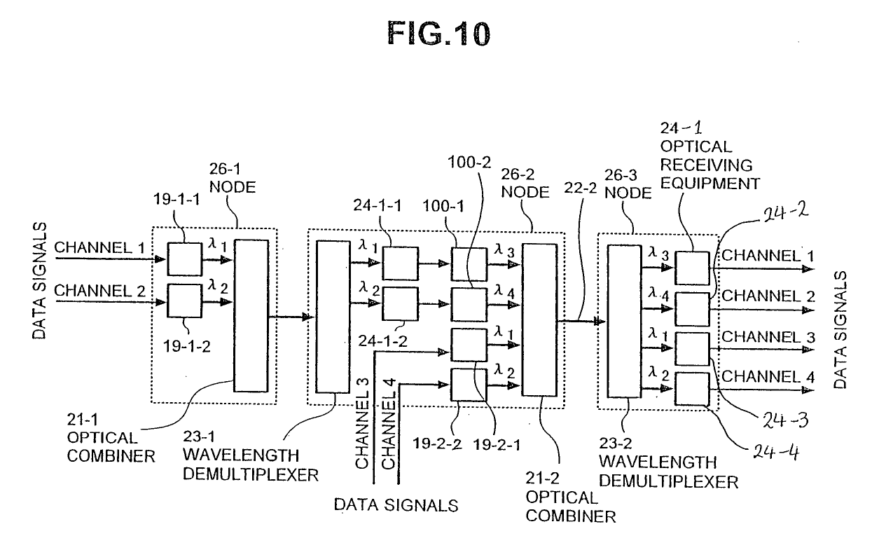

A further embodiment of the WDM network according to this invention is explained with reference to FIG. 10. FIG. 10 is a block diagram of the WDM network. Composed of nodes 26-1, 26-2 and 26-3, this network uses a system that enables data transmission from the node 26-1 to the node 26-3 with four wavelengths by combining the two conventional systems of data transmission between the nodes 26-1 and 26-2 and between the nodes 26-2 and 26-3 with two wavelengths λ1 and λ2.

At the node 26-1, two pieces of wavelength fixed optical transmission equipment 19-1-1 and 19-1-2 are used to multiplex wavelengths λ1 and λ2 for data channels 1 and 2 through an optical combiner 21-1, and the output from the optical combiner 21-2 is then transmitted to the node or a transponder 26-2. At the node 26-2, two pieces of fixed wavelength optical transmission equipment 19-2-1 and 19-2-2 are used to multiplex wavelengths λ1 and λ2 for data channels 3 and 4 through an optical combiner 21-2, and the output from the optical combiner 21-2 is then transmitted to the node 26-3. Also, at the node 26-2, the wavelength multiplexed signal that was sent from the node 26-1 is demultiplexed or divided into wavelengths λ1 and λ2 by wavelength demultiplexer 23-1. The optical signal at wavelength λ1 and λ2 is once converted into electric signals through optical receiving equipment 24-1-1, 24-1-2 and are subsequently converted into optical signals at wavelengths at λ3 and λ4 by wavelength tunable optical transmission equipment 100-1 and 100-2. The two optical signals at wavelengths λ3 and λ4 from channels 1 and 2 are combined with the optical signal at wavelengths λ1 and λ2 from channels 3 and 4 through an optical combiner 21-2 before being transmitted to node 26-3. At the node 26-3, the wavelength demultiplexer 23-2 divides the combined signal into wavelengths λ1 through λ4, which are converted into electric data signals by optical receiving equipment 24-1 through 24-4. Signals in channels 1 and 2 have been converted to have wavelengths λ3 and λ4 as a result of wavelength conversion at the node 26-2. Advantageously, in this embodiment, transmission between nodes 26-1 and 26-3 is made possible by wavelength conversion at the node 26-2 without modifying the equipment at the node 26-1.

A device that combines optical transmission equipment and optical receiving equipment with its transmission wavelength stabilized at a prescribed level is called an optical transponder. In general, on the light receiving side, the wavelength demultiplexer works with high accuracy so the optical receiving equipment may have a broad bandwidth for wavelengths including λ1 through λ4. For this reason, the transponder which combines optical receiving equipment and wavelength tunable optical transmission equipment is flexible enough to be able to receive and send signals at any of the wavelengths λ1 to λ4. On the other hand, a conventional transmission system have as many transponders as a number of wavelengths for a transponder failure because the transmission wavelength is fixed for each transponder. By providing a transponder with the wavelength tunable optical transmission equipment according to the current invention as an auxiliary transponder, even if any of the fixed wavelength transponders fails in the network, the failed transponder is replaced by the auxiliary transponder. This decreases the required number of auxiliary transponders.

According to this invention, an arrangement is made to disallow output optical signals during the wavelength tuning process and allow output of optical signals after the tuning is finished so that wavelength tunable optical transmission equipment for a WDM system does not affect the characteristics of communications at other wavelengths. In addition, a cost-efficient WDM network is implemented using wavelength tunable optical transmission equipment according to the current invention.

We claim:

1. Wavelength tunable optical transmission equipment, comprising:
a wavelength tunable optical transmitter for transmitting an optical signal at one selected wavelength from a predetermined range of wavelengths, the selected wavelength being obtained by changing from a current wavelength to the selected wavelength via a plurality of the predetermined range of the wavelengths;
an optical gate connected to said wavelength tunable optical transmitter for selectively blocking the optical signal from being further transmitted via output based upon a gate control signal; and
a controller connected to said optical gate for generating the gate control signal so as to control said optical gate, the gate control signal being indicative of closing said optical gate while said wavelength tunable optical transmitter changing the current wavelength to the selected wavelength.

2. The wavelength tunable optical transmission equipment according to claim 1 further comprising an optical gate drive circuit connected to said optical gate and said controller for driving said controller based upon sad gate control signal.

3. The wavelength tunable optical transmission equipment according to claim 1 further comprising an optical modulator connected to said optical gate and said wavelength tunable optical transmitter for modulating the optical signal.

4. The wavelength tunable optical transmission equipment according to claim 3 further comprising an optical modulator drive circuit connected to said optical modulator for driving said optical modulator.

5. The wavelength tunable optical transmission equipment according to claim 1 further comprising an optical modulator connected to the output of said optical gate for modulating the optical signal.

6. The wavelength tunable optical transmission equipment according to claim 5 further comprising an optical modulator drive circuit connected to said optical modulator for driving said optical modulator.

7. The wavelength tunable optical transmission equipment according to claim 1 wherein said wavelength tunable optical transmitter further comprises:
a wavelength tunable optical source for generating the optical signal at a variable wavelength;
an optical divider connected to said wavelength tunable optical source for dividing the optical signal; and
a wavelength monitor connected to said optical divider for monitoring the divided optical signal.

8. Wavelength tunable optical transmission equipment, comprising:
a wavelength tunable optical transmitter for transmitting an optical signal at one selected wavelength from a predetermined range of wavelengths, the selected wavelength being obtained by changing from a current wavelength to the selected wavelength via a plurality of the predetermined range of the wavelengths;
an optical-signal level controller connected to said wavelength tunable optical transmitter for selectively controlling the optical signal from being further transmitted via output based upon a level control signal; and
a controller connected to said optical-signal level controller for generating the level control signal indicative of an output signal level from said optical-signal level controller, the level control signal being at substantially zero while said wavelength tunable optical transmitter changing the current wavelength to the selected wavelength.

9. Wavelength tunable optical transmission equipment according to claim 8 wherein said wavelength tunable optical transmitter further comprises:
a wavelength tunable optical source for generating the optical signal at a variable wavelength;
a first optical divider connected to said wavelength tunable optical source for dividing the optical signal; and
a first wavelength monitor connected to said first optical divider for monitoring the divided optical signal.

10. Wavelength tunable optical transmission equipment according to claim 8 wherein said optical-signal level controller further comprises:
an optical attenuator for attenuating the optical signal;
a second optical divider connected to said optical attenuator for further dividing the optical signal; and
a second wavelength monitor connected to said second optical divider for monitoring the further divided optical signal.

11. The wavelength tunable optical transmission equipment according to claim 8 further comprising an optical modulator connected to said optical signal level controller and said wavelength tunable optical transmitter for modulating the optical signal.

12. The wavelength tunable optical transmission equipment according to claim 11 further comprising an optical modulator drive circuit connected to said optical modulator for selectively driving said optical modulator.

13. The wavelength tunable optical transmission equipment according to claim 8 further comprising an optical modulator connected to the output of said optical signal level controller for modulating the optical signal.

14. The wavelength tunable optical transmission equipment according to claim 13 further comprising an optical modulator drive circuit connected to said optical modulator for selectively driving said optical modulator.

15. An optical transponder, comprising:
optical receiving equipment for receiving an optical signal; and
wavelength tunable optical transmission equipment connected to said optical receiving equipment for transmitting the optical signal at one selected wavelength from a predetermined range of wavelengths, the selected wavelength being obtained by changing from a current wavelength to the selected wavelength via a plurality of the predetermined range of the wavelengths, the optical signal being selectively blocked for transmission while said wavelength tunable optical transmitter changing the current wavelength to the selected wavelength.

16. The optical transponder according to claim 15 wherein said wavelength tunable optical transmission equipment further comprises:
wavelength tunable optical transmitter for transmitting the optical signal;
an optical gate connected to said wavelength tunable optical transmitter for selectively blocking the optical signal from being further transmitted via output based upon a gate control signal; and
a controller connected to said optical gate for generating the gate control signal so as to control said optical gate, the gate control signal being indicative of closing said optical gate while said wavelength tunable optical transmitter changing the current wavelength to the selected wavelength.

17. The optical transponder according to claim 16 wherein said wavelength tunable optical transmission equipment further comprises a modulator connected to said optical gate and said wavelength tunable optical transmitter for modulating the optical signal.

18. The optical transponder according to claim 16 wherein said modulator is built in said wavelength tunable optical transmitter.

19. An optical transmission system, comprising:
an optical transmission equipment for transmitting a first combined optical signal containing first data sets at a first predetermined wavelength;
a transponder connected to said optical transmission equipment for receiving said combined optical signal and reassigning the first data sets at a second predetermined wavelength while substantially avoiding optical interference, said transponder receiving second data sets at the first predetermined wavelength, said transponder combining the first data sets at the second predetermined wavelength and the second data sets at the first predetermined wavelength into a second combined optical signal, said transponder transmitting the second combined optical signal; and
an optical receiving equipment connected to said transponder for receiving the second combined optical signal and for separating the second combined signal containing the first data sets and the second data sets into single data sets.

20. The optical transmission system according to 19 wherein said transponder further comprises:
a demultiplexer for demultiplexing the first data sets into first single data sets;
optical receiving equipment connected to said demultiplexer;
wavelength tunable optical transmission equipment connected to said optical receiving equipment for transmitting the first single data sets at the second predetermined wavelength, the second predetermined wavelength being obtained by changing from the first predetermined wavelength to the second predetermined wavelength via a predetermined range of wavelengths, the optical signal being selectively blocked for transmission while said wavelength tunable optical transmitter changing the first predetermined wavelength to the second predetermined wavelength;
fixed wavelength optical transmission equipment for transmitting the second data sets at the first predetermined wavelength; and
an optical combiner connected to said fixed wavelength optical transmission equipment and said wavelength tunable optical transmission equipment for combining the first data sets at the second predetermined wavelength and the second data sets at the first predetermined wavelength into a second combined optical signal.

21. The optical transmission system according to 19 wherein said transponder further comprises:
a selector receiving the first data sets and the second data sets and selectively outputting one of the first data sets and the second data sets, the selected one data set being used for recovery in response to a failure in transmission; and
wavelength tunable optical transmitter connected to said selector for transmitting the selected one data set at a desired wavelength, the desired wavelength being obtained by changing from current wavelength of the selected one data set to the desired wavelength via a predetermined range of wavelengths, the optical signal being selectively blocked for transmission while said wavelength tunable optical transmitter changing the current wavelength to the desired wavelength.

22. A method of substantially avoiding interference in tuning the wavelength of an optical signal, comprising:
transmitting an optical signal at one selected wavelength from a predetermined range of wavelengths, the selected wavelength being obtained by changing from a current wavelength to the selected wavelength via a plurality of the predetermined range of the wavelengths;
selectively blocking the optical signal from being further transmitted via output based upon a gate control signal; and
generating the gate control signal indicative of blocking the optical signal from being further transmitted while the current wavelength is being changed to the selected wavelength.

23. The method of substantially avoiding interference in tuning the wavelength according to claim 22 further comprising:
generating the optical signal at a variable wavelength;
dividing the optical signal; and
monitoring the divided optical signal.

24. A method of substantially avoiding interference in tuning the wavelength, comprising:
transmitting an optical signal at one selected wavelength from a predetermined range of wavelengths, the selected wavelength being obtained by changing from a current wavelength to the selected wavelength via a plurality of the predetermined range of the wavelengths;
selectively controlling the optical signal from being further transmitted in an optical output signal based upon a level control signal; and
generating the level control signal indicative of an output signal level of the optical output signal, the level control signal being at substantially zero while the current wavelength is being changed to the selected wavelength.

25. The method of substantially avoiding interference in tuning the wavelength according to claim 22 further comprising:
generating the optical signal at a variable wavelength;
dividing the optical signal; and
monitoring the divided optical signal.

26. The method of substantially avoiding interference in tuning the wavelength according to claim 25 wherein said selectively controlling further comprises:
attenuating the optical signal;
further dividing the optical signal; and
monitoring the further divided optical signal.

27. A method of substantially avoiding interference in tuning the wavelength, comprising the steps of:
a) transmitting a first combined optical signal containing first data sets at a first predetermined wavelength;
b) receiving said combined optical signal;
c) reassigning the first data sets at a second predetermined wavelength while substantially avoiding optical interference;
d) receiving second data sets at the first predetermined wavelength;
combining the first data sets at the second predetermined wavelength and the second data sets at the first predetermined wavelength into a second combined optical signal;
e) transmitting the second combined optical signal; and
f) receiving the second combined optical signal and for separating the second combined signal containing the first data sets and the second data sets into single data sets.

28. The method of substantially avoiding interference in tuning the wavelength according to 27 wherein said steps b) through e) further comprises:
g) demultiplexing the first data sets into first single data sets;
h) transmitting the first single data sets at the second predetermined wavelength;
i) tuning from the first predetermined wavelength to the second predetermined wavelength via a predetermined range of wavelengths;
j) selectively blocking the transmission while the first predetermined wavelength is being tuned to the second predetermined wavelength;
k) transmitting the second data sets at the first predetermined wavelength; and
l) combining the first data sets at the second predetermined wavelength and the second data sets at the first predetermined wavelength into a second combined optical signal.

29. The method of substantially avoiding interference in tuning the wavelength according to 27 further comprising the additional steps of:
m) receiving the first data sets and the second data sets;
n) selectively outputting one of the first data sets and the second data sets, the selected one data set being used for recovery in response to a failure in transmission; and
o) transmitting the selected one data set at a desired wavelength, the desired wavelength being obtained by changing from current wavelength of the selected one data set to the desired wavelength via a predetermined range of wavelengths; and
p) selectively blocking said step o) of transmitting while the current wavelength is being tuned to the desired wavelength.
